(19) United States
(12) Patent Application Publication
(10) Pub. No.: US 2025/0214461 A1
(43) Pub. Date: Jul. 3, 2025

(54) CHARGING INFRASTRUCTURE, VEHICLE CONTACT UNIT, SYSTEM AND METHOD FOR ESTABLISHING A CONDUCTIVE CONNECTION

(71) Applicant: Easelink GmbH, Graz (AT)

(72) Inventors: Friedrich LOBENSTOCK, Graz (AT); Fabian LUTTENBERGER, Graz (AT); Thomas SCHANZER, Graz (AT); Sebastian LASSACHER, Graz (AT)

(21) Appl. No.: 18/853,205

(22) PCT Filed: Apr. 4, 2023
(86) PCT No.: PCT/EP2023/058853

§ 371 Date: Oct. 1, 2024

(30) Foreign Application Priority Data
Apr. 4, 2022 (DE) 20 2022 103 788.4
Jul. 14, 2022 (DE) 10 2022 117 653.3

(51) Int. Cl. B60L 53/16; B60L 53/35

(52) U.S. Cl. CPC B60L 53/16; B60L 53/35

(57) ABSTRACT

A charging infrastructure for establishing a conductive connection with a vehicle contact unit. The charging infrastructure has a ground contact unit which has a plate-shaped base body and a plurality of contacts arranged on a charging surface of the base body, against which the vehicle contact unit can come to rest. The plurality of contacts includes at least one protective earth contact, power contacts and at least one control contact for detecting a contacting. The at least one protective earth contact is hardwired. The power contacts are assigned to at least one potential. The at least one control contact is formed separately from the power contacts and separately from the at least one protective earth contact. A vehicle contact unit, a system and a method of establishing a conductive connection.

### FIELD OF THE INVENTION

The invention relates to a charging infrastructure for establishing a conductive connection with a vehicle contact unit. Furthermore, the invention relates to a vehicle contact unit for establishing a conductive connection with a ground contact unit. In addition, the invention relates to a system for establishing a conductive connection. Furthermore, the invention relates to a method of establishing a conductive connection between a ground contact unit and a vehicle contact unit.

### BACKGROUND

In the case of at least partially electrically driven vehicles, for example plug-in hybrid vehicles and purely electric vehicles, the batteries of the vehicles must be charged regularly, preferably after each journey. To this end, the vehicle is connected to a corresponding power source, usually using a plug, for example a so-called type 2 plug, which has to be manually inserted by a person into a corresponding socket on the vehicle. This ensures at the same time that the plug is guided so that the contact is made in a defined manner.

The prior art, for example WO 2019/052962 A1, furthermore discloses ground contact units for vehicle battery charging systems, which are provided on the ground. The ground contact units can automatically establish a conductive connection with a corresponding vehicle contact unit provided on the vehicle to be charged to charge the vehicle. The vehicle contact unit can be provided on the underbody of the vehicle, wherein it moves downwards to establish the electrical contacting with the ground contact unit.

For example, the ground contact unit is designed as a so-called matrix charging pad, as shown in WO 2019/052962 A1. For this purpose, the ground contact unit comprises a multitude of contacts arranged in a matrix-like manner, the contacts being adapted to be contacted by means of the vehicle contact unit to establish an electrical connection between the ground contact unit and the vehicle contact unit.

It may be provided that the vehicle contact unit is precisely aligned with respect to the ground contact unit before a connector of the vehicle contact unit contacts the ground contact unit at a defined point. Alternatively, it may be provided that no guide is provided for the vehicle contact unit and/or no precise contacting, a touchdown point of the connector of the vehicle contact unit then having to be detected on the ground contact unit. Depending on the touchdown point, the correspondingly occupied contacts of the ground contact unit are connected to establish the electrical connection via these contacts.

However, the methods of detecting the touchdown point known from the prior art are complicated or associated with high costs.

### SUMMARY

In this respect, the object of the invention is to provide a cost-effective way of detecting a contacting.

According to the invention, the object is achieved by a charging infrastructure for establishing a conductive connection with a vehicle contact unit. The charging infrastructure comprises a ground contact unit having a plate-shaped base body and a plurality of contacts arranged on a charging surface of the base body, against which the vehicle contact unit can come to rest. The plurality of contacts includes at least one protective earth contact, power contacts and at least one control contact for detecting a contacting. The at least one protective earth contact is hardwired. The power contacts are assigned to at least one potential. The at least one control contact is formed separately from the power contacts and separately from the at least one protective earth contact.

According to the invention, the object is furthermore achieved by a vehicle contact unit for establishing a conductive connection with a ground contact unit. The vehicle contact unit has a plurality of contacts which can come to rest on a charging surface of the ground contact unit. The vehicle contact unit is adapted to be moved in a translatory and/or rotary manner in a plane parallel to the charging surface. The plurality of contacts comprises at least one protective earth contact, power contacts and at least one control contact for detecting a contacting. The at least one protective earth contact is hardwired. The power contacts are assigned to at least one potential. The at least one control contact is formed separately from the power contacts and separately from the at least one protective earth contact.

The basic idea of the invention is to detect a contacting of the ground contact unit or the vehicle contact unit when establishing the conductive connection by providing a separately formed control contact via which a control signal can be routed, as a result of which it is determined whether there is a contacting between the vehicle contact unit and the ground contact unit, i.e. a conductive connection. The control contact is formed separately from the power contacts and separately from the at least one protective earth contact, so that a dedicated control signal can be used to detect the corresponding contacting. In other words, the control signal is not a modulation or a high-frequency property of a signal which is provided and evaluated via one of the power contacts, but a specially dedicated control signal. However, it is conceivable that the control signal is a signal which is related to the protective earth (PE) conductor, i.e. PE-related.

In principle, the at least one protective earth contact is hardwired, which means that the corresponding protective earth contact always serves as a protective earth. It is therefore not possible for the protective earth contact to be connected to a potential intended for charging the vehicle, which would allow the protective earth contact to act as a power contact.

It may be provided that the respective power contacts are assigned to the at least one potential via at least one contact switch, which makes it possible to switch the individual power contacts potential-free. This is the case, for example, if not all power contacts contribute to the conductive connection when a contacting is made. The corresponding power contacts which do not contribute to the conductive connection can therefore be switched potential-free via the contact switches.

One aspect provides that at least two power contacts are assigned to the same potential. In this respect, more than one power contact is provided for each potential. The plurality of power contacts connected to a potential therefore represent a power contact plane. The respective power contacts of a power contact plane may be connected to different potentials in groups by providing a corresponding switching unit. The switching unit may be set up to selectively connect power contacts of a first power contact plane to a first potential or to a second potential. In this respect, the switching unit can be used to connect all power contacts of a power contact plane to a selected potential. However, it is not possible to connect individual power contacts of an assigned power contact plane to different potentials. Furthermore, it may also be provided that power contacts of different power contact planes are not connected to a common potential.

In particular, a plurality of potentials is provided, at least two power contacts being assigned to each potential. For example, two potentials or four potentials are provided. This depends on whether it is a DC application or an AC application, in particular a three-phase application. In the case of four potentials, these can be formed by a neutral (N) and three phases (L1, L2, L3).

A further aspect provides that the charging infrastructure includes a monitoring circuit which is set up to monitor the contacting of the at least one control contact. In particular, the monitoring circuit may be set up to determine a touchdown position of the vehicle contact unit. Detecting the contact only ensures that there is a contact with the vehicle contact unit somewhere on the charging surface of the ground contact unit, which can accordingly be determined by the monitoring circuit, which for this purpose recognizes the control signal running across the control contact. To this end, a control signal is applied in a simple way to all control contacts, a continuous connection via one of the control contacts being recognized upon contacting. However, it is not yet possible to determine the touchdown position, i.e. where the vehicle contact unit contacts the ground contact unit.

However, the monitoring circuit may also be set up to determine the touchdown position of the vehicle contact unit on the charging surface of the ground contact unit. This means that it is possible to determine the position on the ground contact unit, in particular on the charging surface, at which the vehicle contact unit contacts the charging surface. This is possible, for example, by applying the control signal to the control contacts individually or in groups, to initially determine a rough area on the charging surface of the ground contact unit. Theoretically, it is also possible to apply different control signals to the control contacts, an evaluation of the control signal of the continuous connection then allowing a conclusion to be drawn about the touchdown position of the vehicle contact unit.

During monitoring by means of the monitoring circuit, it can also be determined whether a displacement of the vehicle contact unit relative to the ground contact unit and/or a rotation about an axis perpendicular thereto occurs, which results in an interruption of a control contact connection, i.e. the connection via the at least one control contact.

In particular, the at least one control contact and the power contacts are designed such that the connection via the at least one control contact breaks first before the connection via the power contacts breaks. This makes it possible for the monitoring circuit, which detects the breaking of the connection via the control contact, to drive a switch-off device so that the corresponding power contacts are switched potential-free before the connection via the power contacts breaks. This effectively prevents arcing or other effects which have to be avoided.

The breaking of the conductive connection can be detected in particular in a direction which is perpendicular to the contacting direction, i.e. in the plane in which the contacting occurs. It is determined whether the vehicle contact unit slips or shifts relative to the ground contact unit, which can cause the connection via the at least one control contact to break.

The switch-off device may comprise a main switch, for example a contactor. The main switch can then be opened to create a galvanic isolation. Alternatively or additionally, the switch-off device may comprise an electronic power control which reduces the applied potential to a non-critical value.

In other words, the driving of the switch-off device corresponds to a fault protection, as the state of the contact switches is checked, the main switch being opened in the event of a fault to switch the contacts potential-free, and/or the applied potential being reduced in value. Alternatively or additionally, this is carried out when the existing contacting suddenly breaks or is not terminated in a controlled manner.

In principle, the monitoring circuit may be provided as a part of the charging infrastructure or in the vehicle, so that the corresponding monitoring can also be carried out on the vehicle side.

For example, the at least one control contact has a smaller surface than the at least one protective earth contact and/or than one of the power contacts, in particular than each of the power contacts. This ensures that, in the event of a relative displacement of the vehicle contact unit to the ground contact unit, the connection established via the at least one control contact breaks first, before the connection via the power contacts and/or the connection via the protective earth contact breaks. In this respect, the power contacts can be actively switched potential-free before the connection thereof breaks and/or an arc would occur.

According to a further aspect, the plurality of contacts comprises at least two control contacts, so that the charging infrastructure is set up to detect a contacting orientation of the vehicle contact unit on the charging surface by means of the at least two control contacts. In particular, the plurality of contacts comprises two categories of control contacts which differ with regard to the control signals used, which are routed via the control contacts. For example, the control signals are inverted with respect to each other and/or have different signal forms so that they can be distinguished from each other. Electrical faults such as short circuits or shunts can thus be reliably detected. It may also be provided that the corresponding control signals which run across the at least two different control contacts are generated with a time offset with respect to each other, as a result of which no valid signal would be generated in the event of any short circuits or shunts. In principle, due to the at least two control contacts located in a contacting area which is formed when the conductive connection between the vehicle contact unit and the ground contact unit is established, it can be ensured that the relative orientation of the vehicle contact unit to the ground contact unit can be determined. Based on the determined orientation, the power contacts can then be connected to corresponding potentials to provide a wiring of the power contacts adapted with respect to the determined relative orientation.

In addition, the at least one protective earth contact can be formed by a continuous surface which provides a protective earth plane which is interrupted by the power contacts and/or the at least one control contact. The corresponding protective earth plane is also referred to as PE plane. In other words, a connection surface, for example a charging surface of the ground contact unit, can be formed for the most part by the protective earth contact, the corresponding power contacts being arranged in the plane formed by the protective earth contact, in particular with an annular insulating area, to electrically insulate the power contacts from the protective earth contact, i.e. from the corresponding protective earth plane. Likewise, the control contact can be electrically isolated from the protective earth plane by means of an annular insulating area.

One aspect provides that the contacts are designed such that, in the event of a relative movement of the vehicle contact unit with respect to the ground contact unit, the at least one control contact loses the contacting with the ground contact unit earlier than the power contacts and/or the at least one protective earth contact. Alternatively or additionally, the at least one protective earth contact can lose the contacting with the ground contact unit later than the power contacts in the event of a relative movement of the vehicle contact unit with respect to the ground contact unit. For example, the at least one control contact is smaller and/or shorter or has a shorter spring travel than the power contacts and/or the at least one protective earth contact. Furthermore, it may be provided that the at least one control contact is designed to be smaller and/or shorter or with a smaller spring travel than the power contacts. This ensures that a connection established via the at least one control contact breaks first, before a connection at the power contacts or at the at least one protective earth contact would break.

In the vehicle contact unit, it may in particular be provided that the corresponding contacts are designed to be resilient, the corresponding spring travels being different, to ensure that the corresponding connections break at different times in the event of a relative movement of the vehicle contact unit with respect to the ground contact unit.

In principle, it may be provided that the at least one protective earth contact is the last to lose contact in the event of a relative movement of the vehicle contact unit with respect to the ground contact unit. In other words, the contact via the at least one protective earth contact is the last to break. To this end, it may be provided, among other things, that the at least one protective earth contact is designed to be larger than the at least one control contact and/or the power contacts.

It may also be provided that the at least one protective earth contact of the vehicle contact unit, in particular the center of the at least one protective earth contact, is arranged on a circular line having a radius which is greater than a radius of a circular line on which the at least one protective earth contact of the ground contact unit is arranged, in particular the center of the at least one protective earth contact. Alternatively, it may be provided that the at least one protective earth contact of the ground contact unit, in particular the center of the at least one protective earth contact, is arranged on a circular line having a radius which is greater than a radius of a circular line on which the at least one protective earth contact of the vehicle contact unit is arranged, in particular the center of the at least one protective earth contact. As a result, the connection via the protective earth contacts breaks last in the event of a relative movement of the vehicle contact unit with respect to the ground contact unit.

In principle, the respective protective earth contact may be arranged on a circular line having a different radius than neighboring power contacts and/or control contacts.

According to the invention, the object is further achieved by a system for establishing a conductive connection, wherein the system has a vehicle contact unit including a plurality of contacts comprising at least one protective earth contact, power contacts and at least one control contact for detecting a contacting The system further has a ground contact unit having a plate-shaped base body and a plurality of contacts arranged on a charging surface of the base body and comprising at least one protective earth contact, power contacts and at least one control contact for detecting a contacting The at least one protective earth contact, i.e. that of the vehicle contact unit and that of the ground contact unit, is respectively hardwired. The respective power contacts, i.e. those of the vehicle contact unit and those of the ground contact unit, are assigned to at least one potential. The respective at least one control contact, i.e. that of the vehicle contact unit and that of the ground contact unit, is formed separately from the power contacts and separately from the at least one protective earth contact. The vehicle contact unit is adapted to be moved in a translatory and/or rotary manner in a plane parallel to the charging surface. The system comprises a monitoring circuit and a signal generator. Furthermore, the system is set up to apply a control signal to at least one control contact of the ground contact unit or of the vehicle contact unit by means of the signal generator. The system is also set up to detect a contacting of the ground contact unit by means of the monitoring circuit, which is set up to receive and evaluate the control signal generated by the signal generator, which, in the contacted state, runs across the at least one control contact of the vehicle contact unit and/or the at least one control contact of the ground contact unit. With the corresponding system, it can therefore be determined whether the corresponding contacting is present when a conductive connection has been established, in particular with regard to the position and orientation, by routing the corresponding control signal across at least one of the control contacts and evaluating it accordingly.

One aspect provides that the contacts of the ground contact unit and the contacts of the vehicle contact unit are designed such that a connection via the protective earth contact of the ground contact unit and the protective earth contact of the vehicle contact unit persists if the connections via the power contacts have already been broken in the event of a relative movement of the vehicle contact unit with respect to the ground contact unit, in particular due to a relative movement of the vehicle contact unit with respect to the ground contact unit. In particular, a relative displacement of the vehicle contact unit to the ground contact unit is detected, which is perpendicular to the contacting direction, provided that this results in the connection established via the protective earth contact breaking.

A further aspect provides that the at least one control contact of the ground contact unit and/or the at least one control contact of the vehicle contact unit are/is designed such that in the event of a relative movement of the vehicle contact unit with respect to the ground contact unit, a connection via the control contact of the ground contact unit and the control contact of the vehicle contact unit breaks before the connections via the power contacts break. For this purpose, the corresponding control contact may, for example, be designed with a smaller surface than the other contacts. In any case, it is ensured that the monitoring circuit first detects that the connection via the control contact is no longer present, as a result of which the monitoring circuit can drive a switch-down device accordingly, which, for example, switches the power contacts potential-free.

According to the invention, the object is furthermore achieved by a method of establishing a conductive connection between a ground contact unit and a vehicle contact unit. The vehicle contact unit has a plurality of contacts comprising at least one protective earth contact, power contacts and at least one control contact for detecting a contacting. The ground contact unit has a plate-shaped base body and a plurality of contacts arranged on a charging surface of the base body and comprising at least one protective earth contact, power contacts and at least one control contact for detecting a contacting. The at least one protective earth contact is respectively hardwired. The respective power contacts are assigned to at least one potential, wherein the respective at least one control contact is formed separately from the power contacts and separately from the at least one protective earth contact. The vehicle contact unit is adapted to be moved in a translatory and/or rotary manner in a plane parallel to the charging surface. The method comprises the following steps:
applying a control signal to the at least one control contact of the ground contact unit or of the vehicle contact unit, and
measuring whether the control signal is transmitted via a continuous connection which comprises at least the control contact of the ground contact unit and/or the control contact of the vehicle contact unit.

In particular, the continuous connection may be provided between the control contact of the ground contact unit and the control contact of the vehicle contact unit. However, it may alternatively also be provided that, for example, the control contact of the ground contact unit forms a continuous connection with the protective earth contact of the vehicle contact unit, a continuous connection being also established. In a particular embodiment, this positioning also represents a desired contacting of the ground contact unit, at which a charging current can be released, which can flow via the corresponding power contacts to charge the battery of the vehicle.

One aspect provides that a contacting area of the vehicle contact unit is identified on the ground contact unit by rotating the vehicle contact unit relative to the ground contact unit and/or by connecting through a plurality of control contacts of the ground contact unit individually and/or in groups. A plurality of control contacts may be provided on the ground contact unit, which can be switched through individually or in groups, for example, to determine whether there is a conductive connection via one of the control contacts, which are switched through accordingly. This initially allows a rough determination of the position of the vehicle contact unit on the ground contact unit.

A further aspect provides that an orientation of the vehicle contact unit relative to the ground contact unit is identified by applying different control signals to at least two control contacts of the ground contact unit or of the vehicle contact unit. After a corresponding contacting of the ground contact unit by the vehicle contact unit has been identified, in particular also the position of the contacting area, the relative orientation can be determined. To this end, two different control signals are applied to two control contacts located in the contacting area. This makes it possible to determine the type of the corresponding orientation of the vehicle contact unit relative to the ground contact unit. Based on the detected orientation, the corresponding power contacts can then be connected to specific potentials to ensure an optimal charging process.

Furthermore, it may be provided that a cleaning check is carried out by applying an extra-low protective voltage to the at least one control contact of the ground contact unit, an insulation check being carried out between two contacts of the ground contact unit. It can thus be determined whether the insulation distance between two contacts is maintained, i.e. whether there is any contamination that would prevent this.

In principle, monitoring for protection against accidental contact can be carried out to ensure that unintentional contacting of accessible contacts is possible. Monitoring for protection against accidental contact is carried out continuously during conductive charging. However, it may also be provided that the monitoring for protection against accidental contact is carried out immediately before the charging process.

For this purpose, it is provided, for example, that during the continuous monitoring for protection against accidental contact, the respective switching positions of the contact switches, which are assigned to the power contacts that are not contacted are monitored. These include the power contacts which do not belong to a subset of the contacted contacts, which is why they are accessible from the outside. The subset of contacted contacts corresponds to the contacting area. The subset of the plurality of contacts is therefore assigned to a contacting area of the charging surface, which is covered by a component of the vehicle contact unit when a conductive connection is established between the ground contact unit and the vehicle contact unit. The corresponding subset, i.e. the number of the plurality of contacts located in the contacting area, depends on the size of the ground contact unit and/or the size of the corresponding component of the vehicle contact unit, which interacts with the contacts of the ground contact unit to form the conductive connection, for example a connector of the vehicle contact unit.

The accessible contacts may also be referred to as exposed contacts, since they are not covered by the vehicle contact unit when the conductive connection is present. With the monitoring for protection against accidental contact via the switching positions of the contact switches, it is checked whether the corresponding power contacts are switched potential-free, as is intended for the exposed power contacts, i.e. the power contacts which do not form the conductive connection with the vehicle contact unit.

Alternatively or additionally, the continuous monitoring for protection against accidental contact can consist of continuously monitoring whether the conductive connection which has already been established is maintained or whether the established conductive connection has broken. For this purpose, it may be sufficient to check at least one of the contacts of the subset, since this contact was previously contacted. In principle, the at least one contact of the subset used for the continuous check of the protection against accidental contact may be the control contact across which the control signal is routed, which is monitored accordingly.

The monitoring for protection against accidental contact may be performed using the monitoring circuit, which monitors the switching position of the contact switches and/or the continuous contacting of the corresponding contact of the subset, i.e. of the control contact.

In an extreme example, it may be provided that all contacts of the ground contact unit are occupied, so that there are no exposed contacts in the contacted state. Accordingly, the subset of the plurality of contacts may correspond to all contacts of the ground contact unit. Typically, the ground contact unit however has more contacts than are needed for a conductive connection between the ground contact unit and the vehicle contact unit. It is thus ensured, among other things, that the vehicle does not have to stop exactly over a specific area of the ground contact unit, thus providing greater flexibility. The component of the vehicle contact unit which covers the contacting area may be a movable part of the vehicle contact unit, for example a movable charging nozzle or similar, which is moved from a vehicle underbody towards the ground contact unit to establish the conductive connection. The movable part of the vehicle contact unit can also be generally referred to as a connector.

In principle, a defined control signal can be fed in via the at least one control contact of the vehicle contact unit or the ground contact unit, which interacts with an associated contact of the other unit, for example a control contact, as a result of which a circuit in which the corresponding control signal can be evaluated is closed.

If two control contacts are provided in the vehicle contact unit and/or the ground contact unit, to which in addition different control signals are applied, it is possible to determine the orientation of the vehicle contact unit in relation to the ground contact unit when the conductive connection is present, i.e. the contacting orientation. Regardless thereof, it is possible to form two channels with two control contacts, a corresponding redundancy being thus created.

The control signal may be a safety extra-low voltage.

In particular, the contacts are designed and arranged such that in a contacting area, at least two control contacts of the vehicle contact unit and/or two control contacts of the ground contact unit are always part of the contacted contacts.

Furthermore, the respective contacts are arranged and dimensioned such that there is no short circuit when there is a contacting. This also applies in the event that the vehicle contact unit shifts relative to the ground contact unit, in particular in the contacting plane.

### BRIEF DESCRIPTION OF THE DRAWINGS

Further advantages and features of the invention will become apparent from the following descriptions and drawings, to which reference is made and in which:

FIG. 1 shows a schematic overview of a system according to the invention with a charging infrastructure according to the invention and a vehicle contact unit according to the invention,

FIG. 2 shows a schematic top view of a ground contact unit of a charging infrastructure according to the invention in accordance with one embodiment,

FIG. 3 shows a schematic top view of a ground contact unit of a charging infrastructure according to the invention in accordance with a second embodiment,

FIG. 4 shows a schematic representation of the electrical wiring of the power contacts in a charging infrastructure according to the invention, and

FIG. 5 shows a schematic overview of a process representing a method according to the invention of establishing a conductive connection between a ground contact unit and a vehicle contact unit.

### DETAILED DESCRIPTION

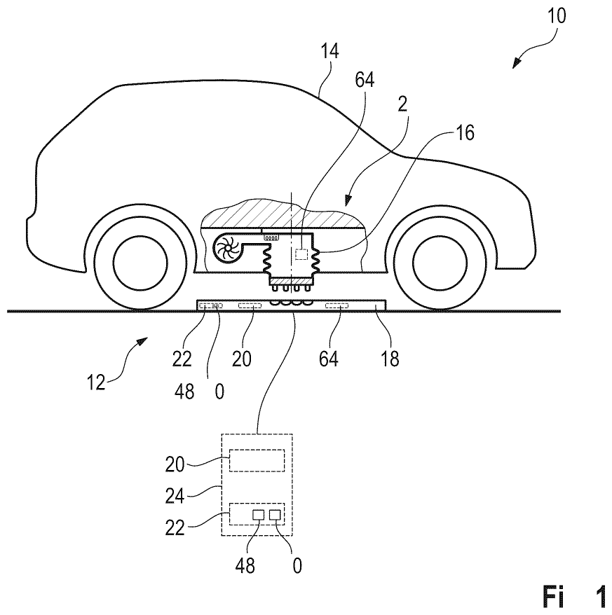

FIG. 1 shows a system 10 which includes an electric charging infrastructure 12 and a vehicle 14 which is at least partially electrically driven. The system 10 may also be referred to as a vehicle battery charging system.

The vehicle 14 has a vehicle contact unit 16 which can make a conductive connection with a ground contact unit 18 of the electric charging infrastructure 12 to charge a battery of the vehicle 14, which is not shown in more detail here.

The electric charging infrastructure 12 has a monitoring circuit 20 and a switch-off device 22, which can be fully integrated into the ground contact unit 18. Alternatively, the monitoring circuit 20 can be arranged partially in the ground contact unit 18 and partially in a monitoring unit 24 formed separately from the ground contact unit 18. Furthermore, it may be provided that the monitoring circuit 20 and the switch-off device 22 are both completely arranged in the separately formed monitoring unit 24.

The separately formed monitoring unit 24 is therefore optional, which is why it is shown with dashed lines in FIG. 1. Likewise, the monitoring circuit 20 and the switch-off device 22 are shown with dashed lines, as their respective position can vary depending on the design. In any case, the separately formed monitoring unit 24 would be electrically connected to the ground contact unit 18, as indicated in FIG. 1.

Alternatively, it may however also be provided that the monitoring circuit 20 and/or the switch-off device 22 are provided on the vehicle side.

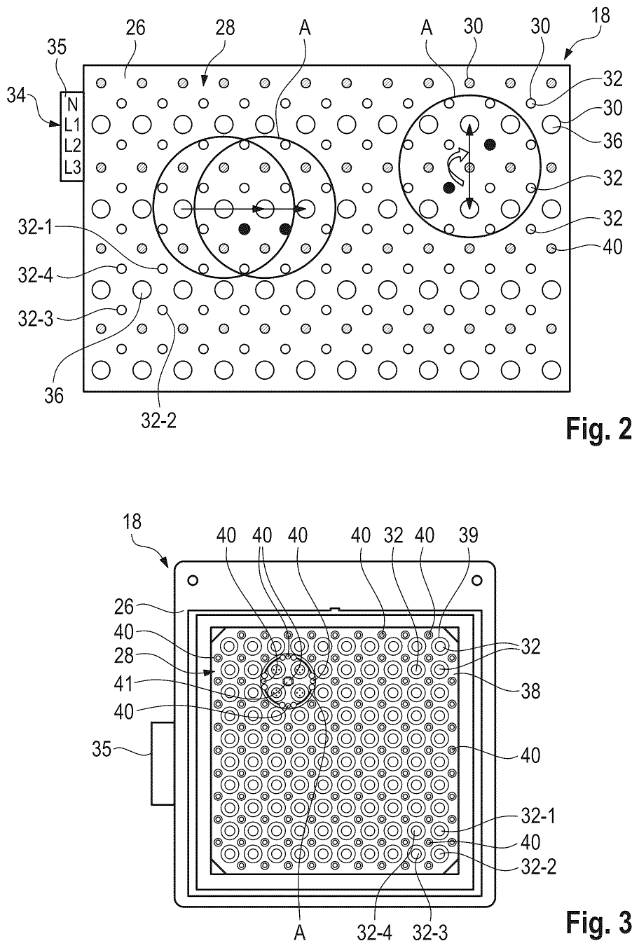

FIG. 2 shows a top view of the ground contact unit 18 of the charging infrastructure 12 according to one embodiment.

The ground contact unit 18 has a plate-shaped base body 26, which has a charging surface 28 which is exposed before the conductive connection is established. The charging surface 28 is an exposed charging surface when the contacting between the ground contact unit 18 and the vehicle contact unit 16 is established.

However, the charging surface 28 can, in principle, be covered by a cover (not shown here) when not in use, so that the charging surface 28 is protected from environmental influences, among other things. The corresponding cover can be removed manually or automatically, the charging surface 28 being thus freely accessible.

A plurality of contacts 30 is provided on the charging surface 28, the contacts being of different contact forms or contact types.

In any case, the contacts 30 include, among others, a plurality of power contacts 32, which are used for the charging process of the battery of the vehicle 14. When the vehicle 14 is charged, in particular when the battery of the vehicle 14 is charged, a charging current flows through at least a part of the power contacts 32. For this purpose, the corresponding power contacts 32 are generally assigned to at least one potential 34, as will be explained below.

In the embodiment shown, the ground contact unit 18 is designed as a three-phase ground contact unit 18, which means that the individual power contacts 32 can be assigned to four different potentials 34, namely the neutral N and the phases L1, L2 and L3. The neutral N is also referred to as the neutral conductor. Accordingly, these are the corresponding potentials N, P1, P2 and P3.

As can be seen from FIG. 2, a corresponding three-phase connection 35 is therefore provided, in particular for the ground contact unit 18.

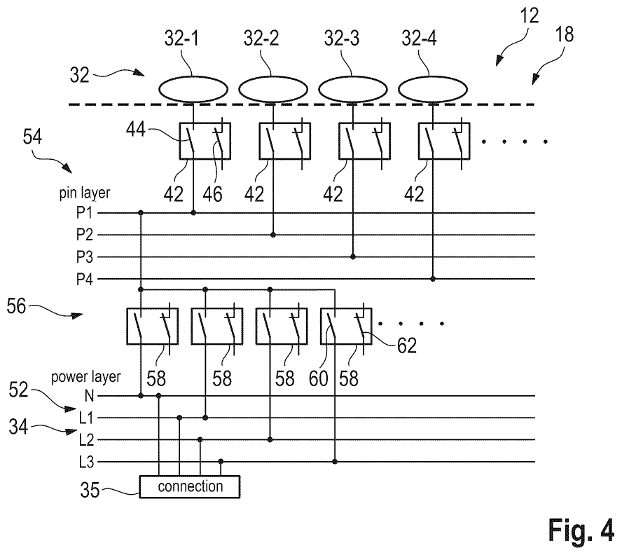

The power contacts 32 are thus divided into power contact planes P1, P2, P3, P4 or assigned to the power contact planes, which are also referred to as “pin layers”. In this respect, there are four types of power contacts 32, namely first power contacts 32-1, which are assigned to the first power contact plane P1, second power contacts 32-2, which are assigned to the second power contact plane P2, third power contacts 32-3, which are assigned to the third power contact plane P3, and fourth power contacts 32-4, which are assigned to the fourth power contact plane P4. This is clearly shown in FIG. 4, to which reference will be made below when describing the interconnection of the power contacts 32.

It is already apparent from FIG. 2 that the four types of power contacts 32 are arranged in a rectangle, in particular in a rectangle on the charging surface 28.

In the example embodiment shown, the first power contact 32-1 is provided in an upper right corner of the rectangle, whereas the second power contact 32-2 is provided in the lower right corner of the rectangle. The third power contact 32-3 is provided in a lower left corner of the rectangle, whereas the fourth power contact 32-4 is provided in an upper left corner of the rectangle. In this respect, the four types of power contacts 32 together form the rectangle in the corresponding plane.

In addition to the power contacts 32, the contacts 30 also include at least one protective earth contact 36, i.e. a PE contact. In the embodiment shown in FIG. 2, a plurality of protective earth contacts 36 is provided, which are arranged separately and isolated from the power contacts 32 on the charging surface 28.

Furthermore, it can be seen from the embodiment shown in FIG. 2 that the protective earth contacts 36 are each arranged in the center of the rectangles.

The rectangles are particularly designed as squares so that the protective earth contact 36 arranged in the center is at the same distance from each of the power contacts 32. In this respect, FIG. 2 provides for a centered square pattern with regard to the power contacts 32 and the protective earth contacts 36.

Alternatively to the embodiment shown in FIG. 2, the ground contact unit 18 can have a continuous protective earth plane 38, which therefore substantially corresponds to the surface of the base body 26 or the base surface of the charging surface 28, as shown in FIG. 3.

The individual power contacts 32 then break through the corresponding protective earth plane 38, the power contacts 32 being each arranged in an insulated manner with respect to the protective earth plane 38, for example by means of annular insulating sections 39 which insulate the power contacts 32 from the protective earth plane 38.

In addition, the contacts 30 can generally comprise at least one control contact 40, which is used to carry out a contacting check, that is to determine whether the vehicle contact unit 16 contacts the ground contact unit 18, which will be discussed below.

In the embodiments shown in FIGS. 2 and 3, a plurality of control contacts 40 is provided.

Generally, the control contacts 40 and/or the protective earth contacts 36 can be designed as magnetic contacts 41, i.e. can be magnetized. This makes it possible for the established conductive connection to be established only in a defined manner, namely such that at least one magnetic contact 41 of the vehicle contact unit 16 couples with a magnetic contact 41 of the ground contact unit 18.

The defined connection is ensured because the magnetic contacts 41 are each arranged in the center of an associated rectangle, in particular a square, in each corner of which one type of the power contacts 32 is provided, i.e. a first power contact 32-1, a second power contact 32-2, a third power contact 32-3 and a fourth power contact 32-4. Consequently, either a protective earth contact 36 or a control contact 40 can be provided in the center of the respective rectangle.

In particular, the contacts 30 are generally distributed on the charging surface 28 and arranged in relation to each other such that at least two control contacts 40 are located in a contacting area A of the charging surface 28 which is covered by the vehicle contact unit 16 when the conductive connection is established. The two control contacts 40 in the contacting area A can then be used to determine the orientation in which the ground contact unit 18 has been contacted.

Furthermore, by knowing the geometry of the vehicle contact unit 16, it can be determined which contacts 30 have been contacted, that is, which of the contacts 30 belong to the subset of the contacted contacts 30 that are located in the contacting area A of the charging surface 28.

Based on this information, the corresponding power contacts 32 can then be switched to assign or connect a specific potential 34 to the different power contact planes P1 to P4.

FIG. 4 shows using an example of an embodiment how the power contacts 32 are connected. This basically applies to the connection of the power contacts 32 of the vehicle contact unit 16 and to the connection of the power contacts 32 of the ground contact unit 18.

The individual power contacts 32 can each be connected to a corresponding power contact plane P1 to P4 via contact switches 42, so that the individual power contacts 32 can be switched on or off via the contact switches 42. This makes it possible to connect only those power contacts 32 of a corresponding potential 34 which are located in the contacting area A, so that exposed power contacts 32 are potential-free.

FIG. 4 also shows that the respective contact switches 42 are designed as mirror contacts, so that the contact switches 42 have a main contact 44 and a monitoring contact 46. The design as a mirror contact ensures that the main contact 44, which acts as a relay, is mechanically coupled to the monitoring contact 46, so that the respective switching positions of the main contact 44 and the monitoring contact 46 are conditioned or dependent on each other. However, the main contact 44 and the monitoring contact 46 are galvanically isolated from each other, so that both contacts 44, 46 are not assigned to a common circuit. Rather, both contacts 44, 46 are assigned to different circuits which are independent of each other and also galvanically isolated from each other.

In this respect, there is no switching position of the contact switch 42 in which a closed circuit is formed in which both the main contact 44 and the monitoring contact 46 are integrated, so that a current could flow across both contacts 44, 46 of the contact switch 42. As shown in FIG. 4, the main contact 44 is designed as a normally open contact, i.e. an NO contact, whereas the monitoring contact 46 is designed as a normally closed contact, i.e. an NC contact.

FIG. 4 thus shows the initial position of the contact switches 42, since the contact switches 42 are each in a corresponding switching position in which the main contacts 44 are open, so that no current flow to the power contacts 32 is possible. In other words, the power contacts 32 are not connected to any potential 34, thus ensuring protection against accidental contact.

The corresponding protection against accidental contact can be monitored in that the monitoring circuit 20 monitors, among other things, the respective switching position of the monitoring contacts 46 of the corresponding contact switches 42.

The monitoring takes place at least at the contact switches 42 which are assigned to power contacts 32 which are not contacted when the conductive connection is present between the ground contact unit 18 and the vehicle contact unit 16, that is, for power contacts 32 which do not belong to the subset of the plurality of contacts 30 of the ground contact unit 18 which is contacted.

The monitoring circuit 20 drives the switch-off device 22 if the monitoring circuit 20 determines that one of the monitoring contacts 46 has an incorrect switching position, which results in one of the main contacts 44 also having an incorrect switching position, since the monitoring contacts 46 and the main contacts 44 are mechanically coupled to each other.

The incorrect switching position corresponds to an open switching position of the monitoring contact 46, which is accompanied by a closed switching position of the associated main contact 44, which would mean that a freely accessible power contact 32 would be assigned to a potential 34, although this is not desired because the corresponding power contact 32 is exposed.

The switch-off device 22 changes its state due to the driving by the monitoring circuit 20, which may be accompanied by a complete switching-off or a complete disconnection. In other words, the switch-off device 22 can be configured such that a galvanic isolation of all power contacts 32 is performed, as a result of which all power contacts 32 would be switched potential-free.

In this respect, the switch-off device 22 can comprise a main switch 46 or a contactor which performs the corresponding galvanic isolation.

Alternatively, the switch-off device 22 can comprise an electronic power control 50 which is designed to reduce the voltage assigned to the potential 34 accordingly, so that the applied voltage is limited to an non-critical value, thus ensuring protection against accidental contact. In other words, the voltage applied to the respective power contact 32, which is coupled to the erroneously closed main contact 44 of the contact switch 42, is so low that there is no danger.

Furthermore, FIG. 4 shows that an input interface 52 is provided, which is assigned to the connection 35 and the potentials 34.

Furthermore, an output interface 54 is provided, which is connected to the power contacts 32, in particular the power contact planes P1 to P4.

In addition, a switching unit 56 is provided which is provided between the input interface 52 and the output interface 54.

The switching unit 56 has a plurality of switches 58 basically set up to switch the power contacts 32 respectively assigned to a power contact plane P1 to P4 together selectively between a first potential 34 and a second potential 34, for example between neutral N and the first phase L1.

This occurs in particular depending on the orientation of the vehicle contact unit 16 with respect to the ground contact unit 18, as determined via the control contacts 40.

The switching unit 56 ensures, for example, that at least the first power contacts 32-1, i.e. the power contacts 32 which are assigned to the first power contact plane P1, can selectively be connected to the first potential 34 (neutral N) or to the second potential 34 (first phase L1).

In the embodiment shown in FIG. 4, the switching unit 56 is configured such that all power contact planes P1 to P4, that is, the respective power contacts 32 in groups, can selectively be connected to any of the potential 34 present, so that maximum flexibility is ensured.

The section shown in FIG. 4 shows the four different types of power contacts 32, i.e. a first power contact 32-1, a second power contact 32-2, a third power contact 32-3 and a fourth power contact 32-4. In other words, power contacts 32 are shown which are assigned to the first power contact plane P1, the second power contact plane P2, the third power contact plane P3 and the fourth power contact plane P4, or are connected thereto via the corresponding contact switches 42.

Basically, the switches 58 can also be designed as mirror contacts, like the contact switches 42, so that the switches 58 have a main contact 60 and a monitoring contact 62.

In contrast to the power contacts 32, the at least one protective earth contact 36 is hardwired, which means that the at least one protective earth contact 36 or the protective earth plane 38 is fixed and cannot be connected to one of the potentials 34.

This applies equally to the control contacts 40, which are also hardwired.

As already explained above, the at least one control contact 40 is provided to carry out a contacting check, that is, to determine whether the vehicle contact unit 16 has contacted the ground contact unit 18.

In particular, the contacts 30 are generally distributed, dimensioned and/or arranged in relation to each other such that at least two control contacts 40 are located in the contacting area A which is covered by the vehicle contact unit 16 when the conductive connection is established, as can be seen from FIGS. 2 and 3.

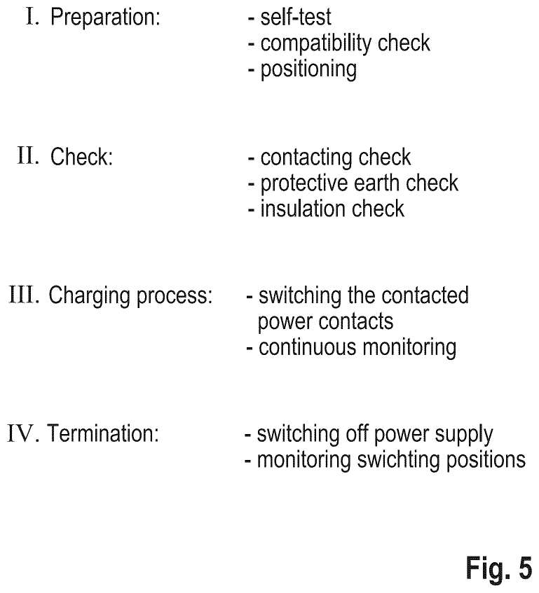

FIG. 5 shows a process which illustrates the steps carried out to initiate and terminate a charging process.

In preparation for the charging process, a self-test of the power contacts 32 can be carried out first to ensure that the contact switches 42 of all power contacts 32 are open. This can be carried out at the beginning to ensure that the ground contact unit 18 and/or the vehicle contact unit 16 are basically in a condition in which a charging process can be carried out at all.

For this purpose, the positions of the contact switches 42 can be monitored by means of the monitoring circuit 20, in particular the monitoring contacts 46.

In addition, the preparation phase can include a compatibility check, in which communication takes place between the ground contact unit 18 and the vehicle contact unit 16 of the vehicle, to determine whether the two contact units 16, 18 can jointly carry out a charging process at all. Corresponding signals are exchanged to determine whether the contact units 16, 18 are compatible with each other.

Subsequently, a positioning can take place during the preparation phase, in which the vehicle 14 is positioned over the ground contact unit 18 or in relation thereto, by outputting corresponding signals, so that, for example, a driver of the vehicle 14 parks the vehicle 14 as precisely as possible over the ground contact unit 18, as a result of which a conductive connection can be established. The signals may be optical and/or acoustic signals. In the case of a vehicle that is at least partially autonomously operated, the positioning can also be carried out automatically. In any case, this makes it possible to minimize the size of the ground contact unit 18.

The vehicle 14 or the vehicle contact unit 16 will then send a charging request to the electric charging infrastructure 12, in particular to the ground contact unit 18. The electric charging infrastructure 12 processes the charging request accordingly. If the result is positive, this is communicated to the vehicle 14 or the vehicle contact unit 16, whereupon the charging process could be initiated.

To this end, the conductive connection between the vehicle contact unit 16 and the ground contact unit 18 is first established by moving at least one component of the vehicle contact unit 16, for example a connector, in the direction of the ground contact unit 18, so that it comes to rest in certain areas on the charging surface 28 of the ground contact unit 18, and at least a subset of the plurality of contacts 30 of the ground contact unit 18 is contacted.

To determine this, a contacting check is carried out to determine whether contacts 30 of the ground contact unit 18 are contacted.

The contact check is carried out via the control contacts 40. For this purpose, at least one control signal, for example an extra-low protective voltage, is applied to the control contacts 40, in particular to at least one of the control contacts 40. The control signal can be generated by a signal generator 64, which is provided on the vehicle side, for example, as a part of the vehicle contact unit 16. Alternatively, the signal generator 64 can be provided on the infrastructure side, for example as a part of the charging infrastructure 12.

In addition, it is measured whether the control signal is transmitted via a continuous connection which at least comprises the control contact 40 of the ground contact unit 18 and/or the control contact 40 of the vehicle contact unit 16 to which the control signal has been applied. For this purpose, the monitoring circuit 20 can be used accordingly.

In addition, it is possible to determine which of the corresponding contacts 30 are contacted by switching through the control contacts 40 individually and/or in groups. If it is determined that there is a continuous connection at one of the control contacts 40, it has been determined that the corresponding control contact 40 is contacted.

By purposefully switching through the control contacts 40, the contacting area A of the vehicle contact unit 16 can be identified on the ground contact unit 18.

After that, the surroundings of the identified control contact 40 can also be switched on to check which (neighboring) control contacts 40 are contacted.

This ensures that a touchdown position of the vehicle contact unit 16 is determined, since it is also possible to determine which other contacts 30 are contacted based on the knowledge of the contacted control contacts 40.

To this end, the fact that the magnetic contacts 41 are provided is utilized, as a result of which the vehicle contact unit 16 only contacts the ground contact unit 18 in a defined manner, namely such that there is a coupling via two magnetic contacts 41, which is also referred to as “snapping”.

The control contacts 40 can also carry different control signals, which can be used to additionally determine the contacting orientation of the vehicle contact unit 16 in relation to the ground contact unit 18. This can also be carried out by means of the monitoring circuit 20.

The charging infrastructure 12 and/or the vehicle contact unit 16 are/is therefore set up to detect a contacting orientation of the vehicle contact unit 16 on the charging surface 28 by means of the at least two control contacts 40.

Depending on the contacting check carried out and the contacting position thus determined, i.e. the touchdown position, and the optionally determined contacting orientation, the contacted power contacts 32 could then be connected to specific potentials 34, in particular via the corresponding switching unit 56.

However, during the checking phase, a protective earth check can additionally take place, in which a test current is passed over at least one contact 30 of the plurality of contacts 30 to determine a contact quality of the present conductive connection between the vehicle contact unit 16 and the ground contact unit 18.

For this purpose, the vehicle 14 can comprise a power generator or a signal generator which provides the test current, which is directed via one of the contacts of the vehicle contact unit 16 to a contact 30 of the contacts 30 of the ground contact unit 18 which is coupled thereto.

For example, one of the power contacts 32 can be used, which is coupled to a corresponding power contact 32 of the vehicle contact unit 16, the corresponding power contact 32 of the ground contact unit 18 having been switched to the protective earth level, which corresponds to the level of the protective earth contact 36. For this purpose, a relay can be provided, via which the corresponding contact 30 is connected to the protective earth level.

Subsequently, a resistance can then be measured to determine the contact quality. In this case, the measured resistance should not exceed a resistance value of 0.1Ω, so that a protective earth resistance threshold value of 0.1Ω is provided. The test current used should have a current strength of at least 200 mA. Alternatively, it may also be provided that the test current is provided by the ground contact unit 18.

A further step provides to carry out an insulation check during checking to determine that there are no leakage or parasitic currents or similar between contacts 30 or other areas of the ground contact unit 18. The insulation check can basically be performed between any two contacts 30 by applying a test voltage and measuring an insulation resistance which is compared to a predetermined insulation resistance threshold value. For example, the test voltage is at least 500 V. The insulation resistance threshold value is, for example, 0.25 MΩ.

The two contacts 30 used for the insulation check can be neighboring contacts on the charging surface 28, in particular two contacts 30 of the subset of contacts 30 which are contacted when the conductive connection is present. An (unwanted) conductive connection is most likely to occur between neighboring contacts 30, for example via an object, dirt or moisture. In particular, the insulation check is carried out between two power contacts 32. Alternatively or additionally, it may be provided that the insulation check is carried out between at least one power contact 32 and the at least one protective earth contact 36. The insulation check can also be carried out between at least one power contact 32 and the control contact 40.

During the insulation check, it is also possible to measure the insulation from a contact 30 of the subset to a point on the charging surface 28 of the base body 26.

Basically, it may be provided that the insulation check is only carried out if it has been previously determined that at least a subset of the plurality of contacts 30 is contacted at all, that is, a conductive connection is present.

Furthermore, the protective earth check can only be carried out if it has been previously determined that a conductive connection is present, i.e. at least the subset of the plurality of contacts 30 is contacted. In addition, the protective earth check can only be carried out if the insulation check has been successfully carried out beforehand.

The insulation check can also be regarded as part of a cleaning check in which an extra-low protective voltage is applied to the at least one control contact 40 of the ground contact unit 18. The insulation check is then carried out between two contacts 30 of the ground contact unit 18.

After the check has been carried out and all check steps have been successfully completed, the charging process can begin.

As already explained above, the power contacts 32 which do not belong to the subset of contacted contacts 30 have already been switched potential-free by the contact switches 42, which has also been checked during the self-test during preparation.

In this respect, only the power contacts 32 of the corresponding potential 34 belonging to the subset of contacted contacts 30 are connected.

The information obtained during the contacting check is then used, as only the power contacts 32 are connected to a potential 34 via the assigned contact switches 42, which are contacted at all to ensure protection against accidental contact. This information is obtained on the basis of the detected touchdown position.

The respective potential 34 is furthermore selected on the basis of the contacting orientation determined during the contacting check.

As explained above, the switching unit 56, in particular the switches 58, is configured such that the power contact planes P1, P2, P3, P4 can be connected to the different potentials 34, for example to neutral N or to one of the phases L1, L2, L3. In this respect, it can thus be set whether the neutral N or one of the phases L1, L2, L3 is present in the upper right corner of a respective rectangle.

This can be applied in an analogous manner to all corners of the rectangle, provided that the switching unit 56 is configured as shown in FIG. 4. Therefore, the respective potential of the corners of the rectangle can be set on the basis of the detected contacting orientation.

In particular, the power contact planes P1, P2, P3, P4 are first connected to the different potentials 34 before the correspondingly contacted power contacts 32 are connected to the power contact planes P1, P2, P3, P4 via the contact switches 42, that is, they are placed on one potential.

After the electrical connection between the contacted power contacts 32 and the corresponding potentials 34 has been established, a charging current can flow from the ground contact unit 18 via the vehicle contact unit 16 into the battery of the vehicle 14, the battery being thus charged accordingly.

During the charging operation, the continuous monitoring for protection against accidental contact takes place, as already explained. It is then determined whether only the contacted power contacts 32 of a corresponding potential 34 are actually connected.

Furthermore, it is checked here whether the existing contacting breaks during the charging operation by continuously monitoring one contact 30 of the subset of contacted contacts, namely the control contact 40.

It is here provided, among other things, that the at least one control contact 40 has a smaller surface than the at least one protective earth contact 36 and/or than one of the power contacts 32, in particular than each of the power contacts 32. In this respect, the connection via the at least one control contact 40 would initially break before the connections via the power contacts 32 and/or the connection via the protective earth contact 36 break(s).

If it is determined that protection against accidental contact is no longer ensured, i.e. the connection via the at least one control contact 40 has been broken, the monitoring circuit 20 drives the switch-off device 22, as a result of which either the main switch 48 is opened to carry out a galvanic isolation and/or the electronic power control 50 regulates the corresponding potential downwards until a non-critical value of the voltage has been reached. The non-critical value can be a voltage which is harmless, in particular a voltage below 25 V alternating voltage, i.e. 25 Vac, or 60 V direct voltage, i.e. 60 Vdc.

Alternatively or in addition to the smaller surface of the at least one control contact 40, it may also be provided that the control contacts 40 are designed with a shorter spring travel than the power contacts 32 and/or the at least one protective earth contact 36, in particular the control contacts 40 of the vehicle contact unit 16. Likewise, the control contacts 40 can be shorter than the power contacts 32 and/or the at least one protective earth contact 36.

In any case, this ensures that, in the event of a relative displacement of the vehicle contact unit 16 with respect to the ground contact unit 18, the connection established via the at least one control contact 40 breaks first before the connection via the power contacts 32 and/or the connection via the protective earth contact 36 breaks. The power contacts 32 can thus be actively switched potential-free or the voltage level can be actively lowered before their connection breaks and/or an arc would occur.

The breaking of the conductive connection is detected in particular in a direction which is perpendicular to the contacting direction, i.e. in the plane in which the contacting occurs. It is therefore determined whether the vehicle contact unit 16 slips or shifts relative to the ground contact unit 18, causing the connection via the at least one control contact 40 to break, in particular to break first.

If no undesired breaking of the conductive connection is detected, the charging process is carried out to the end. Contacting monitoring takes place continuously, as already explained above.

After the charging process has been completed, the conductive connection between the vehicle contact unit 16 and the ground contact unit 18 is actively disconnected.

To do this, the previously connected power contacts 32, which belong to the subset, are first switched potential-free by activating the corresponding contact switches 42.

In addition, the switch-off device 22 can also be driven accordingly, for example to perform a galvanic isolation via the main switch 48. This creates a redundancy. In addition, it is possible to check again whether the power contacts 32 are all potential-free by monitoring the assigned monitoring contacts 46 via the monitoring circuit 20.

The conductive connection is then released by moving the vehicle contact unit 16 away from the resting position so that there is no longer any contact with the ground contact unit 18. The vehicle 14 can then leave the electric charging infrastructure 12.

Finally, a new self-test can be carried out by determining whether all power contacts 32 are in their potential-free state, i.e. whether the associated contact switches 42 are all in the non-current-carrying state, which is the case when the corresponding main contacts 44 are open or the monitoring contacts 46 are closed.

Basically, the self-test can, of course, also be carried out at other times. It is therefore possible to carry out self-tests at several points in time, for example cyclically, to continuously check the readiness of the electric charging infrastructure 12, in particular that of the ground contact unit 18.

In this respect, it is thus ensured that the vehicle 14 can be efficiently charged electrically by establishing a conductive connection. At the same time, appropriate safety precautions are taken by checking whether the ground contact unit 18 is in a state suitable for a charging process.

The process shown in FIG. 5 and the associated method can basically be carried out by the electric charging infrastructure 12, which is set up accordingly for this purpose.

Basically, the vehicle contact unit 16 can be moved in a translatory and/or rotary manner in a plane parallel to the charging surface 28. The vehicle contact unit 16 can even be moved along the charging surface 28, i.e. parallel thereto, when the vehicle contact unit 16 rests on the charging surface 28.

The translatory and/or rotary relative movement of the vehicle contact unit 16 with respect to the charging surface 28 ensures that the contacts 30 of the vehicle contact unit 16 and the contacts 30 of the ground contact unit 18 can come into contact, i.e. overlap.

1. A charging infrastructure for establishing a conductive connection with a vehicle contact unit, wherein the charging infrastructure comprises a ground contact unit having a plate-shaped base body and a plurality of contacts arranged on a charging surface of the plate-shaped base body, against which the vehicle contact unit can come to rest, wherein the plurality of contacts comprises at least one protective earth contact, power contacts and at least one control contact for detecting a contacting, wherein the at least one protective earth contact is hardwired, wherein the power contacts are assigned to at least one potential, wherein the at least one control contact is formed separately from the power contacts and separately from the at least one protective earth contact.

2. The charging infrastructure according to claim 1, wherein at least two power contacts are assigned to a same potential.

3. The charging infrastructure according to claim 1, wherein the charging infrastructure comprises a monitoring circuit which is set up to monitor the contacting of the at least one control contact.

4. The charging infrastructure according to claim 1, wherein the at least one control contact has a smaller surface than the at least one protective earth contact and/or than one of the power contacts.

5. The charging infrastructure according to claim 1, wherein the plurality of contacts includes at least two control contacts, so that the charging infrastructure is set up to detect a contacting orientation of the vehicle contact unit on the charging surface by means of the at least two control contacts.

6. The charging infrastructure according to claim 1, wherein the at least one protective earth contact is formed by a continuous surface which provides a protective earth plane which is interrupted by the power contacts and/or the at least one control contact.

7. A vehicle contact unit for establishing a conductive connection with a ground contact unit, wherein the vehicle contact unit has a plurality of contacts which can come to rest on a charging surface of the ground contact unit, wherein the vehicle contact unit is adapted to be moved in a translatory and/or rotary manner in a plane parallel to the charging surface, wherein the plurality of contacts comprises at least one protective earth contact, power contacts and at least one control contact for detecting a contacting, wherein the at least one protective earth contact is hardwired, wherein the power contacts are assigned to at least one potential, wherein the at least one control contact is formed separately from the power contacts and separately from the at least one protective earth contact.

8. The vehicle contact unit according to claim 7, wherein the plurality of contacts are designed such that, in event of a relative movement of the vehicle contact unit with respect to the ground contact unit, the at least one control contact loses the contacting with the ground contact unit earlier than the power contacts and/or, in the event of the relative movement of the vehicle contact unit with respect to the ground contact unit, the at least one protective earth contact loses the contacting with the ground contact unit later than the power contacts.

9. A system for establishing a conductive connection, wherein the system has a vehicle contact unit including a plurality of contacts comprising at least one protective earth contact, power contacts and at least one control contact for detecting a contacting, wherein the system has a ground contact unit having a plate-shaped base body and a plurality of contacts arranged on a charging surface of the plate-shaped base body and comprising at least one protective earth contact, power contacts and at least one control contact for detecting a contacting, wherein the at least one protective earth contact is respectively hardwired, wherein the respective power contacts are assigned to at least one potential, wherein the respective at least one control contact is formed separately from the power contacts and separately from the at least one protective earth contact, wherein the vehicle contact unit is adapted to be moved in a translatory and/or rotary manner in a plane parallel to the charging surface, wherein the system comprises a monitoring circuit and a signal generator, wherein the system is set up to apply a control signal to at least one control contact of the ground contact unit or of the vehicle contact unit by means of the signal generator, and wherein the system is set up to detect a contacting of the ground contact unit by means of the monitoring circuit which is set up to receive and evaluate the control signal generated by the signal generator, which, in a contacted state, runs across the at least one control contact of the vehicle contact unit and/or the at least one control contact of the ground contact unit.

10. The system according to claim 9, wherein the plurality of contacts of the ground contact unit and the plurality of contacts of the vehicle contact unit are designed such that a connection via the at least one protective earth contact of the ground contact unit and the at least one protective earth contact of the vehicle contact unit persists when the connections via the power contacts have already been broken in the event of a relative movement of the vehicle contact unit with respect to the ground contact unit.

11. The system according to claim 9, wherein the at least one control contact of the ground contact unit and/or the at least one control contact of the vehicle contact unit are/is designed such that a connection via the control contact of the ground contact unit and the control contact of the vehicle contact unit breaks in the event of a relative movement of the vehicle contact unit with respect to the ground contact unit before the connections via the power contacts break.

12. A method of establishing a conductive connection between a ground contact unit and a vehicle contact unit, wherein the vehicle contact unit has a plurality of contacts comprising at least one protective earth contact, power contacts and at least one control contact for detecting a contacting, wherein the ground contact unit has a plate-shaped base body and a plurality of contacts arranged on a charging surface of the plate-shaped base body and comprising at least one protective earth contact, power contacts and at least one control contact for detecting a contacting, wherein the at least one protective earth contact is respectively hardwired, wherein the respective power contacts are assigned to at least one potential, wherein the respective at least one control contact is formed separately from the power contacts and separately from the at least one protective earth contact, wherein the vehicle contact unit is adapted to be moved in a translatory and/or rotary manner in a plane parallel to the charging surface, wherein the method comprises the following steps:
applying a control signal to the at least one control contact of the ground contact unit or of the vehicle contact unit, and
measuring whether the control signal is transmitted via a continuous connection which comprises at least the control contact of the ground contact unit and/or the control contact of the vehicle contact unit.

13. The method according to claim 12, wherein a contacting region (A) of the vehicle contact unit is identified on the ground contact unit by rotating the vehicle contact unit relative to the ground contact unit and/or by connecting through a plurality of control contacts of the ground contact unit individually and/or in groups.

14. The method according to claim 12, wherein an orientation of the vehicle contact unit relative to the ground contact unit is identified by applying different control signals to at least two control contacts of the ground contact unit or of the vehicle contact unit.

15. The method according to claim 12, wherein a cleaning check is carried out by applying an extra-low protective voltage to the at least one control contact of the ground contact unit, wherein an insulation check is carried out between two contacts of the ground contact unit.

16. The charging infrastructure according to claim 2, wherein each potential has at least two power contacts assigned thereto.

17. The charging infrastructure according to claim 3, wherein the monitoring circuit is set up to determine a touchdown position of the vehicle contact unit.

18. The charging infrastructure according to claim 1, wherein the at least one control contact has a smaller surface than each of the power contacts.

19. The charging infrastructure according to claim 5, wherein the plurality of contacts comprises two categories of control contacts which differ with regard to control signals used, which are routed via the control contacts.
